(19) United States
(12) Patent Application Publication
(10) Pub. No.: US 2007/0214137 A1
(43) Pub. Date: Sep. 13, 2007

(54) PROCESS FOR ANALYZING ACTORS AND THEIR DISCUSSION TOPICS THROUGH SEMANTIC SOCIAL NETWORK ANALYSIS

(76) Inventor: Peter A. Gloor, Cambridge, MA (US)

Correspondence Address: BARLOW, JOSEPHS & HOLMES, LTD., 101 DYER STREET, 5TH FLOOR, PROVIDENCE, RI, 02903, US

(21) Appl. No.: 11/682,387

(22) Filed: Mar. 6, 2007

Related U.S. Application Data
(60) Provisional application No. 60/743,414, filed on Mar. 7, 2006.

(51) Int. Cl. G06F 17/30

(52) U.S. Cl. 707/6

(57) ABSTRACT

A method and system is disclosed for producing a combined analysis and visualization that calculates both the ties between actors based on a weighted average of the number of messages exchanged and the weighted number of common terms in the messages exchanged. In addition, another link is calculated based on the number of common terms collected from all of the messages sent by either of the two actors to or from any other actor. Within this framework, a link weight is defined ranging from 0 to 1 and a term weight is inversely defined ranging from 1 to 0. As this weighting value is changed, the visualization is dynamically shifted between placing emphasis on common communication links or common terms.

### CROSS-REFERENCE TO RELATED APPLICATIONS

This application is related to and claims priority from earlier filed U.S. Provisional Patent Application No. 60/743,414, filed Mar. 7, 2006.

### BACKGROUND OF THE INVENTION

The present invention relates generally to a method and system for analyzing and graphically depicting the strength of interrelationships between unrelated documents. More specifically, the present invention relates to a method and system that automatically identifies certain qualities within various unrelated documents such as documents, weights the relative frequency of these qualities and then allows a user to define and customize the graphical depiction of the relationship between the documents based on the similar qualities that exist between the documents and a user defined strength rating of the similarity of the qualities between each document. For example, the network relationship of unrelated documents may be controlled relative to the strength of the underlying social structure that runs through the documents based on the number of physical documents exchanged by various actors. Similarly, the network relationship of unrelated documents may be controlled relative to the strength of the underlying content structure found on the face of the documents based on the similarity of terms within in the physical documents themselves.

In general, the basic goal of any query-based document retrieval system is to find documents that are relevant to the user's input query. Further due to the high quantity of raw data that is generally available, the quality of the document set that is retrieved is also quite relevant. It is important and highly desirable, therefore, to provide a user with the ability to identify various bases for relationships between unrelated documents when compiling large quantities of electronic data. Without the ability to automatically identify such relationships, often the analysis of large quantities of data must generally be performed using a manual process. This type of problem frequently arises in the field of electronic media such as on the Internet where a need exists for a user to access information relevant to their desired search without requiring the user to expend an excessive amount of time and resources searching through all of the available information. Currently, when a user attempts such a search, the user either fails to access documents that are actually because they are not easily identified or the user expends a significant amount of time and energy to conduct an exhaustive search of all of the available documents returned in the search to identify those most likely to be relevant. This is particularly problematic because a typical user search includes only a few search terms and the prior art document retrieval techniques are often unable to discriminate between documents that are actually relevant to the context of the user search and others that simply happen to include the query terms.

In this context, typical prior art search engines for locating discrete documents of interest in a grouping of unstructured documents can be divided into two groups. The first is a keyword-based search, in which documents are ranked on the incidence (i.e., the existence and frequency) of the keywords provided by the user. The second is a categorization-based search, in which information within the documents to be searched, as well as the documents themselves, is pre-classified into “topics” that are then used to augment the retrieval process. The basic keyword search is well suited for queries where the topic can be described by a unique set of search terms. This method selects documents based on exact matches to these terms and then refines searches using Boolean operators (and, not, or) that allow users to specify which words and phrases must and must not appear in the returned documents. However, unless the user can find a combination of words appearing only in the desired documents, the results will generally contain an overwhelming and cumbersome number of unrelated documents to be of use.

Several improvements have been made to the basic keyword search. For example, query expansion is a general technique in which keywords are used in conjunction with a thesaurus to find a larger set of terms with which to perform the search. Query expansion can improve document recall, resulting in fewer missed documents, but the increased recall is usually at the expense of precision (i.e., results in more unrelated documents) due in large part to the increased number of documents returned. Similarly, natural language parsing falls into the larger category of keyword pre-processing in which the search terms are first analyzed to determine how the search should proceed. For example, the query “West Bank” comprises an adjective modifying a noun. Instead of treating all documents that include either “west” or “bank” with equal weight, keyword pre-processing techniques can instruct the search engine to rank documents that contain the phrase “west bank” more highly. Even with these improvements, keyword searches may fail in many cases where word matches do not signify overall relevance of the document. For example, a document about experimental theater space is unrelated to the query “experiments in space” but may contain all of the search terms.

It is also important to note that many of the prior art categorization techniques use the term “context” to describe their retrieval processes, even though the search itself does not actually employ any contextual information. U.S. Pat. No. 5,619,709 to Caid et. al. is an example of a categorization method that uses the term “context” to describe various aspects of their search. Caid's “context vectors” are essentially abstractions of categories identified by a neural network. In the method described in Caid, searches are performed by first associating, if possible, keywords with topics (context vectors), or allowing the user to select one or more of these pre-determined topics, and then comparing the multidimensional directions of these vectors with the search vector via the mathematical dot product operation (i.e., a projection). However in operation, this process is identical to the keyword search in which word occurrence vectors are projected in conjunction with a keyword vector. These techniques therefore should not be confused with techniques that actually employ contextual analysis of whole language as the basis of their document search engines,

Another technique that attempts to improve the typical results from a key word based searching system is categorization. Categorization methods attempt to improve the relevance by inferring “topics” from the search terms and retrieving documents that have been predetermined to contain those topics. The general technique begins by analyzing the document collection for recognizable patterns using standard methods such as statistical analysis and/or neural network classification. As with all such analyses, word frequency and proximity are the parameters being examined and/or compiled. Documents are then “tagged” with these patterns (often called “topics” or “concepts”) and retrieved when a match with the search terms or their associated topics have been determined. In practice, this approach performs well when retrieving documents about prominent (i.e., statistically significant) subjects. Given the sheer number of possible patterns, however, only the strongest correlations can be discerned using a categorization method. Thus, for searches involving subjects that have not been pre-defined, the subsequent search typically relies solely upon the basic keyword matching method is susceptible to the same shortcomings.

In an effort to further enhance keyword searching and improve its overall reliability and the quality of the identified documents, a number of alternate approaches have been developed for monitoring and archiving the level of interest in documents based on the key word search that produced that document result. Some of these methods rely on interaction with the entire body of users, either actively or passively, wherein the system quantifies the level of interest exhibited by each user relative to the documents identified by their particular search. In this manner, statistical information is compiled that in time assists the overall network to determine the weighted relevance of each document. Other alternative methods provide for the automatic generation and labeling of clusters of related documents for the purpose of assisting the user in identifying relevant groups of documents.

Yet another method that is utilized to facilitate identification of relevant documents is through prediction of relevant documents utilizing a method known as a spreading activation technique. Spreading activation techniques are based on representations of documents as nodes in large intertwined networks. Each of the nodes include a representation of the actual document content and the weighted values of the frequency of each portion of the relevant content found within the document as compared to the entire body of collected documents. The user requested information, in the form of key words, is utilized as the basis of activation, wherein the network is entered (activated) by entering one or more of the most relevant nodes using the keywords provided by the user. The user query then flows or spreads through the network structure from node to node based on the relative strength of the relationships between the nodes.

While spreading activation provides a great improvement in the production of relevant documents as compared to the traditional key-word searching technique alone, the difficulty in most of these prior art predicting and searching methods is that they generally rely on the collection of data over time and require a large sampling of interactive input to refine the reliability and therefore the overall usefulness of the system. As a result, such systems do not reliably work in smaller limited access networks. For example, when a limited group of people is surveyed to determine particular information that may be relevant to them, the survey in itself is generally limited in scope and breadth. Further, the analysis of the survey needs to be performed without then requesting that the participants themselves pour over the survey data to draw the connections and relevant interrelationships.

In view of the foregoing, there is a need for an automatic system for analyzing discrete groups of unstructured documents in order to identify relevant documents and to create an interrelated relevance network that identifies various similarities and interrelationships thereby allowing the various relevant documents within the unstructured group to be correlated in a meaningful manner. There is a further need for an automated system for analyzing discrete groups of relevant documents within an overall body of unstructured documents to create a visual display based on the similarities of the actual contextual use of common terms and/or the weighted average of actual ties (exchanged messages) that extend between actors related to the documents. There is still a further need for such a system to be regulated in a manner that allows a user to increase or decrease the strength of link weighting applied to the analysis of the documents that is in turn used to create the visualization thereby allowing the user to dynamically shift the emphasis of the analysis between common communications or common term frequency.

### BRIEF SUMMARY OF THE INVENTION

In this regard, the present invention provides a method and system for analyzing a discrete group of unrelated input in a manner that draws semantically and contextually based connections between the input in order to quickly and easily identify underling similarities and relationships that may not be immediately visible upon the face of the base input. Further, for the purpose of the present invention, the term document is going to be utilized generally as a structured term to that represents the more abstract term of input.

The system of the present invention builds upon the general structured searching concepts that are referenced above by providing an analysis and visualization method that is user tailored based on a controlled application of an algorithm that combines a relative analysis of communication links and content similarity. Generally, in the context of the present invention, the input for analysis is represented in the form of a large group of unrelated and unstructured documents. The present invention provides a system that wherein the discrete documents within the unstructured document collection are all collected and represented as a plurality of nodes in a network matrix. The documents that are to be analyzed are each added into the overall network (corpus) wherein each document is added at a discrete node corresponding to the document. These nodes are referred to as a document node. Once the documents are bound to the nodes within the corpus, a term frequency-inverse document frequency (tfidf) statistical weighting measure is applied to the document nodes. The tfidf process provides a statistical measure to evaluate the relative weight or importance of a word in the context of its base document and in the context of the overall corpus of unrelated documents. The importance or weight of the word increases proportionally to the number of times a word appears in the document but is also offset by the overall frequency of the same word across the entire corpus.

When analyzing each document in preparation for binding into the corpus, the term frequency within a document is stored as the initial edge weight between that particular term node and the document node. Once the entire corpus is complete the term frequency within the entire corpus is also calculated to provide an overall term frequency that can be utilized to go back to each term node in order to calculate local and global weighting that is applied to the initially calculated edge weights. Finally, the edge weights are normalized with relative weighting values so that the sum of the weights of all edges connected to a given node equals 1.

Once the corpus is built, the ties or relationships can be depicted visually using the method and system of the present invention wherein actors and/or documents are depicted as nodes and interrelationships or similarities in weighting are drawn as lines between the nodes. The closer the two nodes are placed together, the more intensive is their relationship, that is, the more commonality or interaction those actors and/or documents share. Further, the most active actors and/or documents, namely the actors and/or documents that have the most relational links or lines extending therefrom, are placed in the center of the network. Once the visualization has been built, a user can search for groupings of related actors and/or documents by simply searching for and identifying the various clusters within the network.

The power of the system of the present invention is derived from the ability to produce a combined visualization that calculates ties between actors based on a weighted average of the number of messages exchanged and the number of common terms in the messages exchanged. In addition, another link is calculated based on the number of common terms collected from all of the messages sent by either of the two actors to or from any other actor. Within this framework, a link weight is defined ranging from 0 to 1 and a term weight is inversely defined ranging from 1 to 0. As this weighting value is changed, the visualization is dynamically shifted between placing emphasis on common communication links or common terms.

It is therefore an object to provide a method and system for analyzing and visually depicting the underlying relationships between various unstructured documents. It is a further object of the present invention to provide a visualization system for identifying interrelationships between various unstructured documents in a manner that assists in identifying the relative strengths of each of the interrelationships. It is still a further object of the present invention to provide a visualization method for displaying interrelationships between unstructured documents that allows a user to adjust the visualization by selecting between two different interrelationship characteristics that exist between the unrelated documents.

These together with other objects of the invention, along with various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is an illustration depicting a visual array display produced by the visualization and analysis system of the present invention;

FIG. 2 is an illustration depicting two distinct visual arrays based on data relating to email exchanges, wherein the top image employs an interaction weighted analysis and the bottom image employs a term weighted analysis using the method and system of the present invention; and

FIG. 3 is an illustration depicting two distinct visual arrays based on an exemplar web search, wherein the top image employs an interaction weighted analysis and the bottom image employs a term weighted analysis using the method and system of the present invention.

### DETAILED DESCRIPTION OF THE INVENTION

Now referring to the drawings, the method and system for analyzing a discrete group of unrelated input in a manner that draws semantically and contextually based connections between the input in order to quickly and easily identify underlying similarities and relationships that may not be immediately visible upon the face of the base input is shown and generally illustrated.

As was stated above, the system of the present invention builds upon the general structured searching concepts known in the prior art by providing an analysis and visualization method that is user tailored based on a controlled application of an algorithm that combines a relative analysis of communication links and content similarity. It is this visualization that allows a user to identify both the most relevant interactions as well as the most relevant topics (context) at any given time. This can be contrast with prior art systems that were principally concerned with a picture of the overall relationship that existed throughout the entire set of documents. While this allowed various clustered hubs to be identified, there exists a need to further drill down into that data and mine it based on relationships between individual actors and or based on the relative frequency of the common terms that are contained within documents passing between actors.

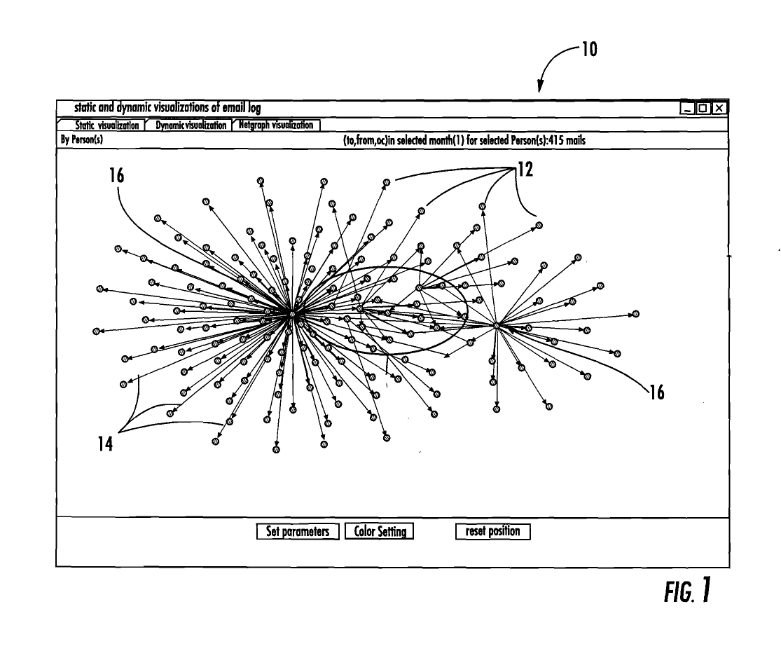

Most generally, the method of the present invention provides for a visual depiction 10 of the various interrelationships that exist within a plurality of unstructured documents 12 such as the one depicted in FIG. 1. In this regard, each of the unstructured documents 12 is illustrated as a node or a dot while the interrelationships 14 between each of those documents 12 is shown generally as a line. In creating the visualization 10, the method of the present invention provides for analyzing a plurality of unstructured documents 12 to determine a first set of data or a characteristic within those documents 12 that relates to an interaction frequency that exists between each discrete document and the remaining documents within the plurality of documents 12. In other words, an interaction frequency is calculated that is a numerical value representing the frequency that each document within the plurality of documents 12 interacts with each of the other documents within the plurality of documents 12. Similarly, the method provides for analyzing the plurality of unstructured documents 12 to determine a second set of data that is related to relative term frequency that each document possesses as compared to the other documents within the plurality of documents 12. The term frequency is a numerical value that represents the relative frequency that each of the documents utilizes a given term as compared to the overall usage of the same term within said plurality of documents 12 and is normalized relative to the term usage throughout all of the documents and the relative length of the document being analyzed. Once the first and second data sets are obtained, each of the documents is positioned in a dynamic visual array 10 wherein spacing between each of the documents 12 in the visual array 10 is determined based on their interaction frequency and their term frequency as will be described in greater detail below.

It should be appreciated that while the term documents is being employed, within the context of the present invention the discrete meaning of documents includes a broad range of concepts including but not limited to documents, discrete elements of data, email communications Web pages, online forum posts and actors that create any of the foregoing. Further, in a preferred embodiment the documents for analysis is represented in the form of a large group of unrelated and unstructured documents that are generated by a plurality of actors. In this context, the first set of data relating to the interaction frequency is calculated based on the interactions between actors while the term frequency is calculated based on the documents exchanged between those actors. By way of example, this input may be email correspondence (interactions) exchanged between suspected terrorists (actors), a set of answers (interactions) provided by a person (actor) in response to a targeted survey, pharmaceutical testing results or any other set of unrelated data that a user may desire to analyze in order to determine the existence of underlying threads, interrelationships or similarities. Each piece of information in the group of documents is then ultimately representationally referred to as a discrete document.

The analysis of the documents to obtain the first and second sets of data allows for each of the discrete documents within the unstructured document collection 12 are all collected and represented as a plurality of nodes in a visual array 10. The documents 12 that are to be analyzed are each added into the overall network (corpus) wherein each document 12 is added at a discrete node corresponding to the document. These nodes are referred to as a document node. Once the documents 12 are bound to the nodes within the corpus, a term frequency-inverse document frequency (tfidf) statistical weighting measure is applied to the document nodes. The tfidf process provides a statistical measure to evaluate the relative weight or importance of a word in the context of its base document 12 and in the context of the overall corpus of unrelated documents 12. The importance or weight of the word increases proportionally to the number of times a word appears in or is used by the document 12 but is also offset by the overall frequency of the same word across the entire corpus.

When analyzing each document 12 in preparation for binding into the corpus, the term frequency within a document 12 is stored as the initial edge weight between that particular term node and the document node. Once the entire corpus is complete the term frequency within the entire corpus is also calculated to provide an overall term frequency that can be utilized to go back to each term node in order to calculate local and global weighting that is applied to the initially calculated edge weights. Finally, the edge weights are normalized with relative weighting values so that the sum of the weights of all edges connected to a given node equals 1.

Once the corpus is built, the ties or relationships can be depicted visually using the method and system of the present invention wherein actors and/or documents 12 are depicted as nodes and interrelationships 14 are drawn as lines between the nodes. The spacing between the nodes within the visual array 10 is determined using a weighting factor that employs the interaction frequency and term frequency value. Generally, the closer the two nodes are placed together, the more intensive is their relationship, that is, the more commonality or interaction those actors and/or documents 12 share. Further, the most active actors and/or documents 12, namely the actors and/or documents 12 that have the most relational links 14 or lines extending therefrom, are placed in the center of the visual array 10. Once the visualization 10 has been built, a user can search for groupings of related actors and/or documents 12 by simply searching for and identifying the various clusters 16 within the visual array 10.

The power of the system of the present invention is derived from the ability to produce a combined visualization that calculates ties between documents 12 based on a weighted average of the number of interactions 14 exchanged between documents 12 and the number of common terms in the messages exchanged. In addition, another link is calculated based on the number of common terms collected from all of the messages sent by either of the two documents 12 to or from any other document 12. Within this framework, an interaction frequency weight is defined ranging from 0 to 1—and a term weight frequency is inversely defined ranging from 1 to 0. As this weighting value is changed, the visual array 10 is dynamically shifted between placing emphasis on common interaction links or common terms.

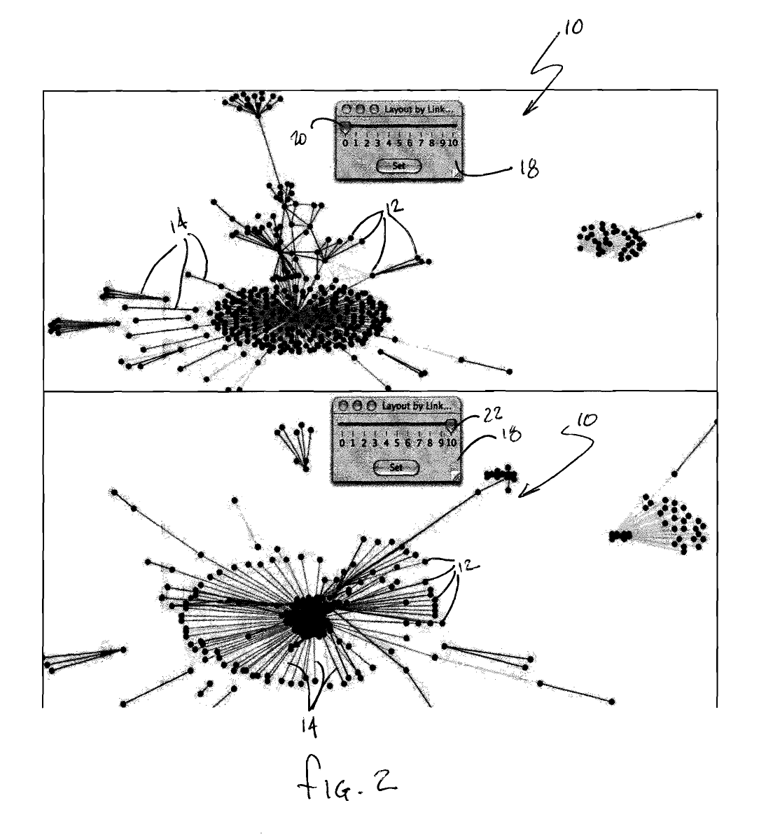

Turning now to a more concrete example as is illustrated in FIG. 2, the visual array 10 depicts an array of documents 12 wherein each of the documents represents an actor. Further, the interrelationships 14 between the actors depict email messages exchanged between the actors. In this context, the top picture in FIG. 2 shows a the visual array 10 wherein the relational links 14 are calculated and weighted based on the social underpinnings of the network wherein the clustering is a result of the actual volume of emails 14 that are exchanged between all of the actors 12 within the group. In this regard, the weighting slider 18 that controls the selective application of the weighting factor as described above has been moved to a position 20 indicated as 0 or being fully weighted using interaction weighting. Accordingly, the actors 12 having the highest interaction level are clustered together and more closely. Alternately, in the bottom picture of FIG. 2, the visual array 10 while based on the same underlying data, has changed. In this case, the weighting slider 18 has been shifted to a position 22 where the full emphasis is placed on term weighting where the links 14 are calculated based on the similarly of terms contained within the documents 12 themselves. In this regard, the clustering is a clustering of documents 12 that share the most common contextual threads. It should be further appreciated that this visualization can be done using a snapshot in time or could be formed as a temporal visualization. In this regard, changes in interaction or changes in term frequencies can easily be tracked as the visual array changes in time. Similarly, it should be appreciated that the weighting factor can be changed dynamically at any point of the temporal visualization process thereby changing the weighting relatively between interaction weighted and term weighted.

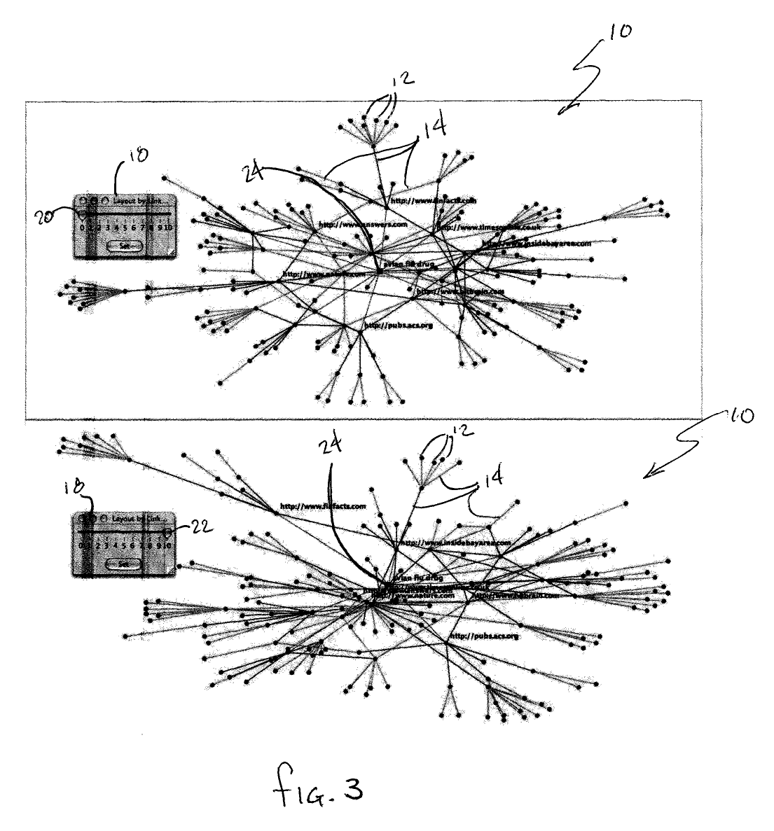

A similar example of a visual array 10 is provided in FIG. 3, represents the results of a Google® search using the term “avian flu drug”. In this case each of the documents 12 represents a webpage that was returned by the search, while the interrelationship lines 14 are links between each of the documents 12 (web pages). As was described above, the top picture in FIG. 3 the weighting slider 18 is positioned 20 so that the visual array 10 is fully weighted based on interaction weighting. That is the web pages 12 are clustered based on the overall intensity of their interrelationships 14 in terms of link frequency. Alternately, in the bottom picture of FIG. 3, the visual array 10 while based on the same underlying data, has changed. In this case, the weighting slider 18 has been shifted to a position 22 where the full emphasis is placed on term weighting where the links 16 are calculated based on the similarly of terms contained within the web pages 12 themselves. In this regard, the clustering is a clustering of documents 12 that share the most common contextual threads. With the weighting shifted in this manner it appears that the most relevant webpage is the one document 24 positioned at the center of both of the visual arrays 10 in the top and bottom picture of FIG. 3.

It can therefore be seen that the present invention provides a unique system that has broad applicability in areas such as counter terrorism, consumer survey data analysis, psychological profiling or any other area were a range of unrelated information needs to be quickly reviewed and distilled to identify patterns or relationships. Each document is bound to the corpus in a manner that provides the ability to identify interrelationships between the documents. For these reasons, the present invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A method for analyzing and visually depicting interrelationships that exist within a plurality of unstructured documents, the method comprising the steps of:
analyzing said plurality of unstructured documents to determine a first set of data related to an interaction frequency;
analyzing said plurality of unstructured documents to determine a second set of data related to a term frequency; and
positioning each of said documents in a dynamic visual array wherein spacing between each of the documents in the visual array is determined based on their interaction frequency and their term frequency.

2. The method of claim 1, wherein said documents are selected from the group consisting of: documents, discrete elements of data, email communications, Web pages, online forum posts, and actors that create any of the foregoing.

3. The method of claim 1, said interaction frequency is a numerical value that represents the frequency that each document within said plurality of documents interacts with each of the other documents within said plurality of documents, and
said term frequency is a numerical value that represents the relative frequency that each of the documents utilizes a given term as compared to the overall usage of the same term within said plurality of documents.

4. The method of claim 1, wherein the positioning of each of said documents relative to each of said other documents can be changed by a user selecting a weighting factor.

5. The method of claim 4, wherein said user selected weighting factor places emphasis on said interaction frequency causing those documents having a greater interaction frequency to be positioned more closely to one another.

6. The method of claim 4, wherein said user selected weighting factor places emphasis on said term frequency causing those documents having a greater term frequency to be positioned more closely to one another.

7. The method of claim 4, wherein said weighting factor can have a value that falls within a range that extends between fully interaction weighted and fully term weighted.

8. The method of claim 1, wherein documents having high interaction frequencies are placed centrally within said visual array.

9. The method of claim 1, wherein documents having high term frequencies are placed centrally within said visual array.

10. The method of claim 1, wherein said visual array further comprises:
an array of dots, wherein each of said dots depicts each of said documents; and
an array of lines, each of said lines extending between two of said dots within said array of dots, wherein each of said lines represents an interrelationship between said two dots.

11. The method of claim 10, wherein the positioning of said dots within said visual array is based on the interaction frequency of each of said documents corresponding to said dots.

12. The method of claim 10, wherein the positioning of said dots within said visual array is based on the term frequency of each of said documents corresponding to said dots.

13. A method for visually depicting interrelationships that exist between a plurality of actors that exchange interactions therebetween, the method comprising the steps of:
analyzing said plurality of actors that to determine a first set of data related to an interaction frequency;
analyzing said interactions between said plurality of actors to determine a second set of data related to a term frequency within said interactions; and
positioning each of said actors in a dynamic visual array wherein spacing between each of the actors in the visual array is determined based on their interaction frequency and their term frequency.

14. The method of claim 13, wherein said interactions between said actors are selected from the group consisting of: documents, discrete elements of data, email communications, Web pages, and online forum posts.

15. The method of claim 13, wherein said interaction frequency is a numerical value that represents the frequency that each actor within said plurality of actors exchanges an interaction with each of the other actors within said plurality of actors, and
said term frequency is a numerical value that represents the relative frequency that a given term appears in an interaction as compared to the overall usage of the same term within said plurality of interactions.

16. The method of claim 13, wherein the positioning of each of said actors relative to each of said other actors can be changed by a user selecting a weighting factor.

17. The method of claim 16, wherein said user selected weighting factor places emphasis on said interaction frequency causing those actors having a greater interaction frequency to be positioned more closely to one another.

18. The method of claim 16, wherein said user selected weighting factor places emphasis on said term frequency causing those interactions having a greater term frequency to be positioned more closely to one another.

19. The method of claim 16, wherein said weighting factor can have a value that falls within a range that extends between fully interaction weighted and fully term weighted.

20. The method of claim 13, wherein actors having high interaction frequencies are placed centrally within said visual array.

21. The method of claim 13, wherein interactions having high term frequencies are placed centrally within said visual array.

22. The method of claim 13, wherein said visual array further comprises:
an array of dots, wherein each of said dots depicts each of said actors; and
an array of lines, each of said lines extending between two of said dots within said array of dots, wherein each of said lines represents an interaction between said two dots.

23. The method of claim 22, wherein the positioning of said dots within said visual array is based on the interaction frequency of each of said actors corresponding to said dots.

24. The method of claim 22, wherein the spacing between said dots within said visual array is based on the term frequency of said interaction representing the line extending between said dots.
